(19) United States
(12) Patent Application Publication
(10) Pub. No.: US 2007/0000362 A1
(43) Pub. Date: Jan. 4, 2007

(54) Method for positioning rotary knife of cutter and apparatus therefor

(76) Inventor: Chuan-Sheng Lin, Taichung City (TW)

Correspondence Address: HDSL, 4331 STEVENS BATTLE LANE, FAIRFAX, VA, 22033, US

(21) Appl. No.: 11/168,470

(22) Filed: Jun. 29, 2005

(51) Int. Cl. B26D 1/15

(52) U.S. Cl. 83/13; 83/508.3

(57) ABSTRACT

A method and an apparatus for positioning a rotary knife of a cutter. An axial rod includes a roller bump formed on the position where the rotary knife unit is to be disposed. In this manner, the rotary knife unit and the roller bump can be engaged with each other, thereby affixing the rotary knife unit in position. By using a device that can precisely calculate the displacement, the rotary knife unit can be pushed to the position of the roller bump of the axial rod. In this manner, one can precisely control the separation of the rotary knife units, thereby enhancing the quality of paper cutting and the convenience of fabrication.

### BACKGROUND OF THE INVENTION

The present invention relates generally to a method for positioning the rotary knife of a cutter and an apparatus therefor. More particularly, the present invention relates to a method and an apparatus for rapidly positioning the rotary knife of the cutter, and for precisely controlling the separation between each rotary knife, which is applicable to the rotary shaft of the cutter.

As shown in FIG. 1, the conventional rotary knife of a cutter includes a plurality of rotary knife units 2a penetratively disposed on an axial rod 1a. Each rotary knife unit 2a includes a rotary knife 20a and a rotary knife base 21a . The rotary knife base 21a includes a through hole 210a for providing the rotary knife unit 2a to penetrate through the axial rod 1a and be disposed thereon. The rotary knife 20a is thus erectly and securely disposed on one side of the rotary knife base 21a. In order to dispose the rotary knife unit 2a on the axial rod 1a, a thin hole 10a is formed on the axial rod 1a where the rotary knife unit 2a is to be disposed. Each rotary knife base 21a includes a through hole 211a corresponding the thin hole 10a (as shown in FIG. 2), thereby affixing the rotary knife unit 2a to the axial rod 1a by penetrating a bolt 22a through the thin hole 1Oa and the through hole 211a.

However, it is rather difficult to form thin holes 10a on the axial rod 1a, especially by hand. Therefore, there is often a deviation of distances between the thin holes. In addition, the insertion of bolts 22a requires the application of external forces, which can easily crook the rotary knife 20a. As a result, the separation between the rotary knifes 20a can not be controlled precisely, thereby affecting the cutting quality of the cutter.

Accordingly, a new method for positioning the rotary knife of the cutter and a new apparatus therefor is demanding.

Therefore, the inventor of the present invention realized the drawbacks in the conventional art, and developed the present invention that can overcome the drawbacks described above.

### BRIEF SUMMARY OF THE INVENTION

The present invention is to provide a method and an apparatus for positioning the rotary knife of a cutter. The separation between each of the rotary knifes is precisely controlled, so as to enhance the quality of paper cutting and the convenience of fabrication.

In order to achieve the above and other objectives, the method of positioning a rotary knife of a cutter includes the following steps:

a) preparing a axial rod, the axial rod having a roller bump formed substantially on the position where the rotary knife unit is to be disposed;

b) calculating the displacement of the rotary knife unit and moving the rotary knife unit to substantially the position of the roller bump according to the calculated displacement; and

c) engaging the rotary knife unit with the roller bump of the axial rod.

Furthermore, the apparatus for positioning a rotary knife of a cutter of the present invention includes an axial rod and a plurality of rotary knife units separately disposed on the axial rod. Each rotary knife unit includes a rotary knife and a rotary knife base for disposing the rotary knife. The rotary knife base includes a hole for the rotary knife unit to penetrate through the axial rod. In addition, a roller bump is formed on the axial rod for engaging the hole of the rotary knife base therewith.

### BRIEF DESCRIPTION OF THE DRAWINGS

FIG. 1 is an explosive view of a conventional cutter including a rotary knife and an axial rod.

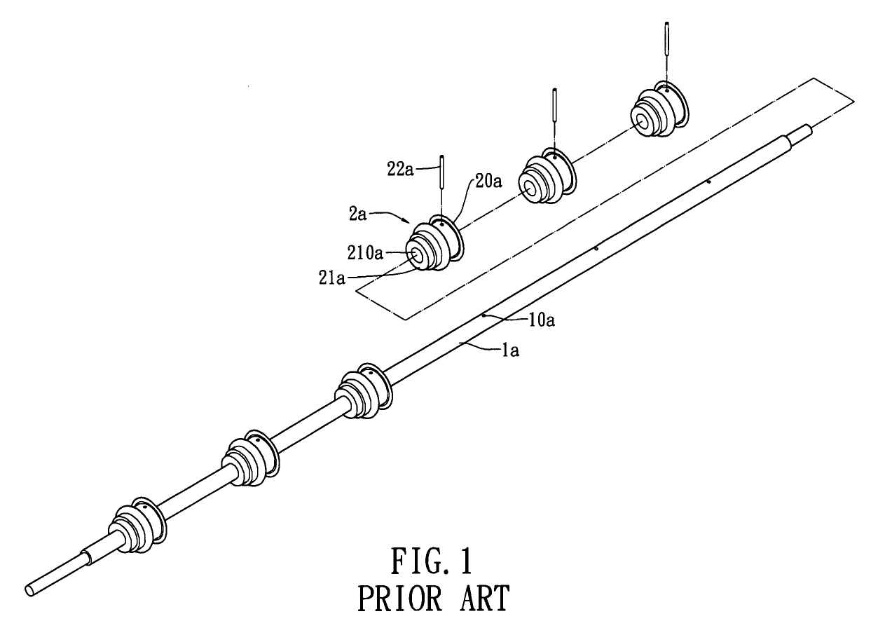

FIG. 2 is a partial explosive view of a conventional cutter including a rotary knife and an axial rod.

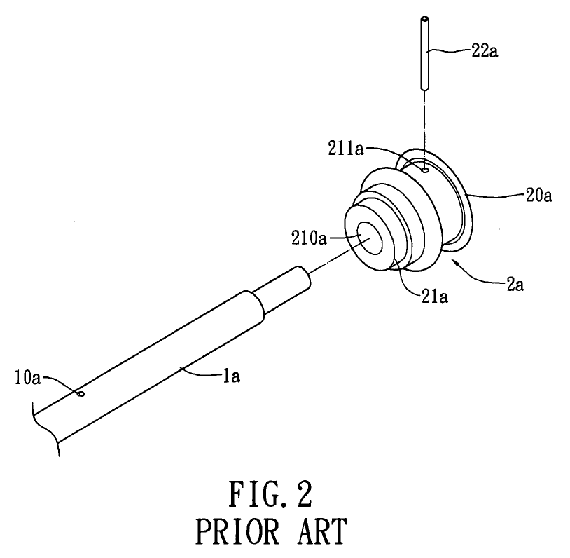

FIG. 3 is an explosive view of a rotary knife and an axial rod of the present invention.

FIG. 4 is a partial explosive view of the rotary knife and the axial rod of the present invention.

FIG. 5 illustrates the first step for inserting the rotary knife unit into the axial rod according to the present invention.

FIG. 6 illustrates the second step for inserting the rotary knife unit into the axial rod according to the present invention.

FIG. 7 illustrates the third step for inserting the rotary knife unit into the axial rod according to the present invention.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

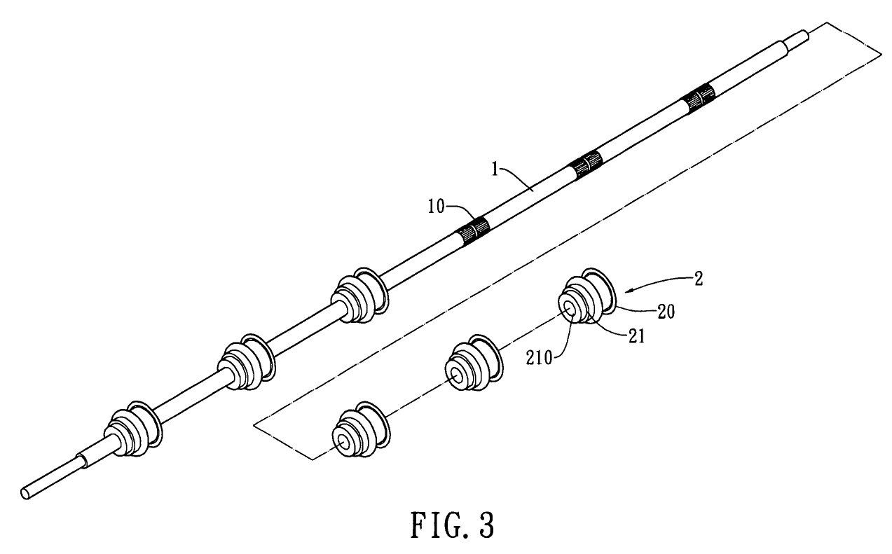

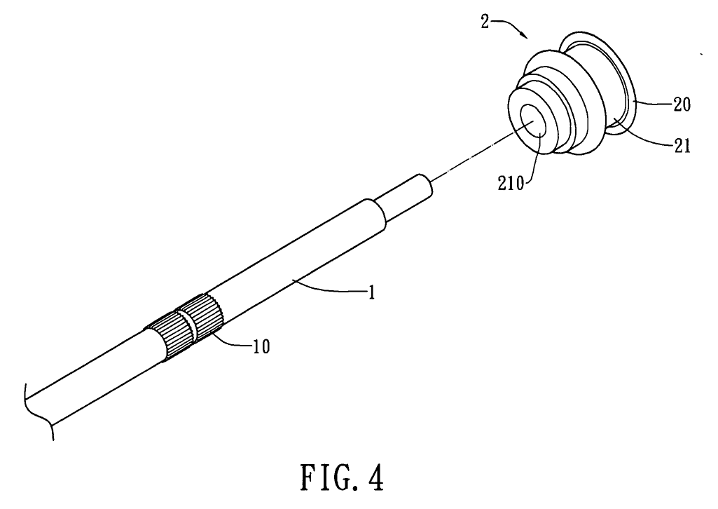

Referring to FIG. 3 and FIG. 4, an explosive view and a partial explosive view of a rotary knife and an axial rod of the present invention are illustrated. The present invention provides a method and an apparatus for positioning the rotary knife of a cutter, so as to more precisely position the rotary knife units of the cutter thereby enhancing the quality of paper cutting. The apparatus for positioning rotary knife includes an axial rod 1 and a plurality of rotary knife units 2 disposed on the axial rod 1. Each rotary knife unit 2 includes a rotary knife 20 and a rotary knife base 21. The rotary knife base 21 is made of a material softer than that of the axial rod 1. For example, the axial rod 1 is made of iron, while the rotary knife base 21 is made of plastic. A hole 210 is formed penetrating the rotary knife base 21. The rotary knife is erectly affixed to one side of the rotary knife base 21.

First, a roller bump 10 is formed on the axial rod 1, where the rotary knife unit 2 is to be disposed thereon. The quantity and location of the roller bump 10 depends on the quantity of the rotary knife units 2 to be disposed and the separation between the rotary knifes 20. In this particular embodiment, six rotary knife units 2 are separately disposed on the axial rod 1 for cutting paper of A4 size into business cards.

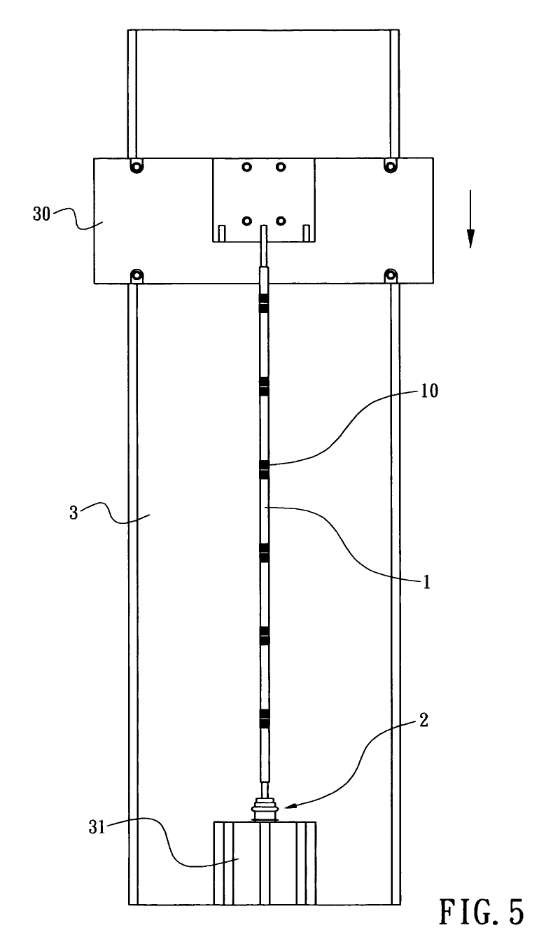

As shown in FIG. 5, a device 3 that can accurately calculate displacements is used to penetrate each of the rotary knife units 2 through the axial rod 1. The device 3 includes a stepper motor or a servomotor (not shown), which can precisely control the displacement of the sliding stage 30. In this particular embodiment, the sliding stage 30 slides upward and downward on the device 3. The sliding stage 30 can also slide horizontally. In addition, a base 31 is formed below the device 3, thereby affixing one end of the axial rod 1 having roller bumps 10 to the sliding stage 30. The rotary knife units 2 to be inserted are then disposed on the base 31, thereby aligning the hole 210 of the rotary knife base 21 to the other end of the axial rod 1.

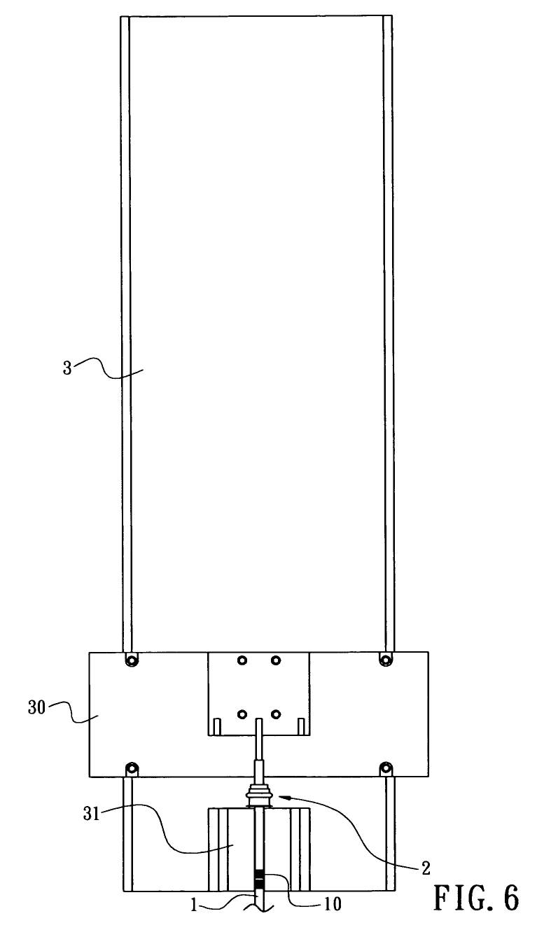

As shown in FIG. 6, the displacement of the rotary knife unit 2 from the other end of the axial rod 1 to the position of the roller bumps 10 is electronically calculated. The device 30 controls the stepper motor to move the sliding stage 30, and push the rotary knife unit 2 to the position of the roller bumps 10 of the axial rod 1. Since the rotary knife base 21 is made of a material softer than that of the axial rod 1, an engagement force is formed between the roller bumps 10 and the rotary knife base 21 when the rotary knife unit 2 is pushed to the position of the roller bumps 10, thereby securely fastening the rotary knife 2 in position.

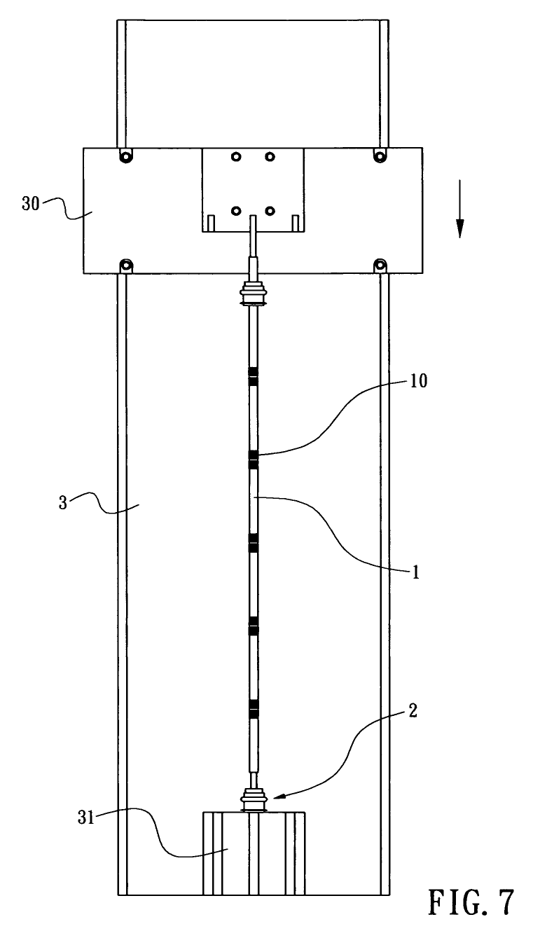

As shown in FIG. 7, the sliding stage 30 is returned to its original position. By repeating the steps in FIG. 5 and FIG. 6, all the rotary knife units 2 will be pushed to the predetermined positions. Moreover, the displacement of the next rotary knife unit 2 can be calculated according to the displacement of the previous rotary knife unit 2. By subtracting the separation between the two rotary knife units from the displacement of the previous rotary knife unit, one obtains the displacement for the next rotary knife unit. For this reason, the position of the roller bumps 10 does not need to be too precise. Some minor errors will not affect the position accuracy and the fastening strength of the rotary knife units 2. Therefore, a knife rotary shaft is manufactured after all the rotary knife units 2 are pushed to the predetermined positions.

Accordingly, the method and the apparatus for positioning a rotary knife of a cutter of the present invention are completed.

Therefore, the rotary knife units 2 are rapidly disposed to the axial rod 1 by using the method and the apparatus of the present invention. No insertion of bolts is necessary to affix the rotary knife base 21 on the axial rod 1. Further, no external force is applied on the axial rod 1. Meanwhile, the rotary knife unit is pushed to the predetermined position by electronically controlling the sliding stage 30. Thus the separation between the rotary knifes 20 of the rotary knife units 2 is controlled precisely, thereby enhancing the quality of paper cutting.

In summary, the present invention indeed satisfies the patentability requirements of the patent law, a grant of letters patent therefor is thus respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

1. A method for positioning a rotary knife of a cutter, comprising the steps of:
a) preparing a axial rod, the axial rod having a roller bump formed substantially on a position where a rotary knife unit is disposed;
b) calculating a displacement of the rotary knife unit and moving the rotary knife unit to a substantial position of the roller bump according to the calculated displacement; and
c) engaging the rotary knife unit with the roller bump of the axial rod.

2. The method as recited in claim 1, further comprising the step of controlling the displacement by a stepper motor or a servomotor.

3. The method as recited in claim 1, further comprising the step of calculating the displacement for next rotary knife unit by subtracting a separation from the displacement of previous rotary knife.

4. An apparatus for positioning a rotary knife cutter apparatus, comprising:
an axial rod;
a plurality of rotary knife units separately disposed on the axial rod, each rotary knife unit comprising a rotary knife and a rotary knife base for disposing the rotary knife, the rotary knife base having a hole for the rotary knife unit penetrating through the axial rod; and
a roller bump teeth protruding from and fixedly formed on the axial rod merely at a location of each rotary knife unit for engaging the hole of the rotary knife base therewith.

5. The apparatus as recited in claim 4, wherein the rotary knife is erectly and securely disposed on one side of the rotary knife base.

6. The apparatus as recited in claim 4, wherein the roller teeth is annularly formed on the axial to engage with each rotary knife base through the hole so that the rotary knife base is fixedly disposed on the axial rod.

7. The apparatus as recited in claim 4, wherein a pair of roller teeth is annularly formed on the axial to engage with each rotary knife base through the hole so that the rotary knife base is fixedly disposed on the axial rod.

8. The apparatus as recited in claim 4, wherein the rotary knife base is made of a material softer than that of the axial rod.

9. The apparatus as recited in claim 8, wherein the rotary knife base is made of plastic and the axial rod is made of iron.
